(19) United States
(12) Patent Application Publication
(10) Pub. No.: US 2012/0086668 A1
(43) Pub. Date: Apr. 12, 2012

(54) INTEGRATED TOUCH CONTROL DEVICE

(76) Inventors: Ching-Yi Wang, Zhongli City (CN); Chen-Yu Liu, Zhongli City (CN)

(21) Appl. No.: 13/254,457

(22) PCT Filed: Jul. 1, 2009
(86) PCT No.: PCT/CN09/72589

§ 371 Date: Sep. 1, 2011

(30) Foreign Application Priority Data
Mar. 3, 2009 (CN) 200910008092.7

(51) Int. Cl. G06F 3/044; G06F 3/045

(52) U.S. Cl. 345/174; 178/18.05; 178/18.06

(57) ABSTRACT

A touch device integrated with capacitive and resistive sensing operation includes a first substrate on which a first electrode pattern is formed and a second substrate on which a second electrode pattern is formed. The first and second electrode patterns are respectively connected to a microprocessor via a first scanning circuit and a second scanning circuit. When a user slightly touches a touch operation surface of the touch device, the touch device is set in a capacitive touch position detection mode. When the user forcibly depresses the touch operation surface of the touch device or carries out a hand writing input operation on the touch operation surface of the touch device, the touch device is set in a resistive touch position detection mode.

### FIELD OF THE INVENTION

The present invention relates to a touch device, and in particular to a touch device integrated with capacitive and resistive operation for being selectively operated in a capacitive touch position detection mode and a resistive touch position detection mode.

### BACKGROUND OF THE INVENTION

A resistive touch panel comprises an ITO (Indium-Tin-Oxide) film and a sheet of ITO glass, which are spaced from each other by a plurality of insulation spacers. When a touching object (such as a stylus) touches and depresses the ITO film, a local depression is formed, which makes a contact with the ITO glass located therebelow thereby inducing a variation of voltage, which, through conversion from analog signal into digital signal, is applied to a microprocessor to be processed for calculation and determination of the operation position of the touched point.

A capacitive touch panel generally makes use of variation of electrical capacity coupling between a transparent electrodes and a conductor to generate an induced current by which the operation position of a touched point can be determined. In the structure of the capacitive touch panel, the outermost layer is a thin transparent substrate, and the second layer is an ITO layer. When a touching object (such as a user's finger) is put in touch with the surface of the transparent substrate, the touching object induces electrical capacity coupling with the electric field on the outer conductive layer, leading to a minute variation of current. A microprocessor may then perform calculation to determine the operation position where the figure touches.

### SUMMARY OF THE INVENTION

However, the resistive touch panel and the capacitive touch panel both suffer certain limitations on the operations thereof and have drawbacks. The resistive touch panel, although having an advantage of low cost, needs to cause physical contact between two conductive layers on the upper and lower sides in the operation thereof. Thus, a pressure must be applied to quite an extent. This often leads to damage of the conductive layers. Also, the sensitivity is low. On the other hand, although having high sensitivity, a capacitive touch panel, due to the operation principle thereof, must be operated with a touching object that is a conductor, such as a user's finger or a touch head, in order to conduct electric current therethrough. The capacitive touch panel cannot be operated with an insulative touching object.

Thus, an objective of the present invention is to provide a touch device integrated with capacitive and resistive operation, which detects the ways how a user touches the touch device and in response thereto, switches the operation thereof between capacitive and resistive touch position detection modes. Thus, when a user slightly touches a touch operation surface of the touch device, the touch device operates in the capacitive touch position detection mode, and when the user forcibly depresses the touch operation surface of the touch device or carries out a hand writing input operation on the touch operation surface of the touch device, the touch device operates in a resistive touch position detection mode.

The technical solution that the present invention adopts to overcome the above discussed problems is a touch device integrated with capacitive and resistive sensing operation, which comprises a first substrate on which a first electrode pattern is formed and a second substrate on which a second electrode pattern is formed. The first and second electrode patterns are respectively connected to a microprocessor via a first scanning circuit and a second scanning circuit.

When a user slightly touches a touch operation surface of the touch device, the touch device is set in a capacitive touch position detection mode in which a change of electrical capacitive coupling between the touching object and the first electrode pattern is applied to the microprocessor for determination of at least one operation position where the touching object operates on the touch operation surface of the first substrate.

When the user forcibly depresses the touch operation surface of the touch device or carries out a hand writing input operation on the touch operation surface of the touch device, the first substrate is depressed at an operation position, causing the first electrode pattern and the second electrode pattern to contact each other, whereby the touch device is set in a resistive touch position detection mode in which the microprocessor determines at least one operation position where the touching object operates on the touch operation surface of the first substrate according to variation of voltage in the second electrode pattern.

With the technical solution adopted in the present invention, the touch device integrated with capacitive and resistive operation in accordance with the present invention, together with a simple circuit structure, when integrated with a simple scanning detection process, is operable in the touch operation mode of either a capacitive touch panel or a resistive touch panel. Constraint in the touching object usable in the conventional resistive touch panel or the capacitive touch panel can be eliminated and the touch control operation of the touch device is simplified. The touch device can be selectively operated in the best touch control mode in accordance with different ways of operation and possesses the advantages of the touch panels of both types.

The present invention is also particularly suitable in the applications where hand writing input is applied to the touch device to effectively solve the problems of unsmooth hand writing input and poor detection result found in the conventional capacitive touch panels.

### BRIEF DESCRIPTION OF THE DRAWINGS

The present invention will be apparent to those skilled in the art by reading the following description of preferred embodiments thereof with reference to the drawings, in which:

FIG. 1 shows a system block diagram of a first embodiment in accordance with the present invention;

FIG. 2 shows an exploded view of major constituent components of FIG. 1;

FIG. 3 shows relative positional relationship between a first electrode pattern and a second electrode pattern after a first substrate and a second substrate of FIG. 1 are bonded together;

FIG. 4 shows a cross-sectional view taken along line 4-4 of FIG. 3;

FIG. 5 schematically demonstrates a touch device in accordance with the present invention being operated by a user's finger;

FIG. 6 shows a table listing capacitance corresponding to a touched position demonstrated in FIG. 5;

FIG. 7 schematically shows the touch device in accordance with the first embodiment of the present invention being operated with a touching object;

FIG. 8 shows a system block diagram of a second embodiment in accordance with the present invention;

FIG. 9 shows a circuit diagram demonstrating a depression operation applied to the touch device of the second embodiment of the present invention;

FIG. 10 shows an equivalent circuit of FIG. 9; and

FIG. 11 schematically shows the touch device in accordance with the second embodiment of the present invention being operated with a touching object.

### DETAILED DESCRIPTION OF THE PREFERRED EMBODIMENTS

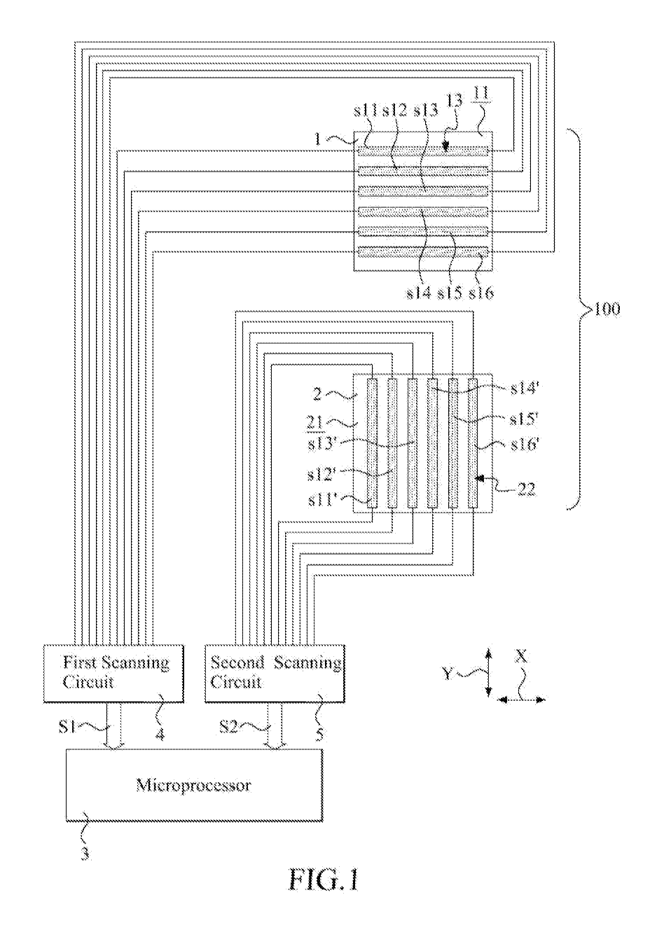

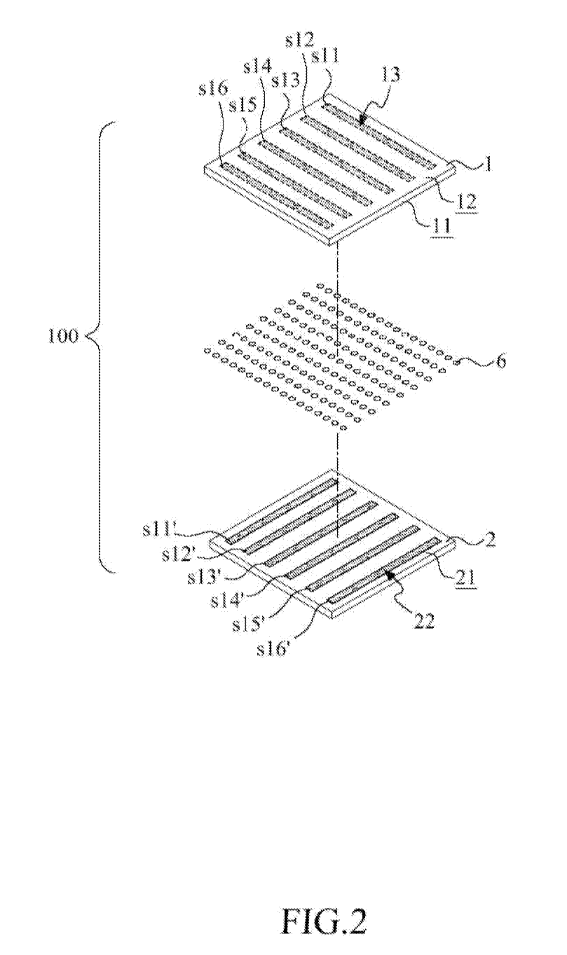

With reference to the drawings and in particular to FIGS. 1 and 2, a system block diagram of a first embodiment in accordance with the present invention is illustrated. FIG. 2 shows an exploded view of major constituent components of FIG. 1. As shown, a touch device integrated with capacitive and resistive sensing operation in accordance with the present invention, generally designated at 100, comprises a first substrate 1, which comprises an insulation film, such as a PET (Polyethylene Terephthalate) film, of which a transparent material can be selected in a practical application. The first substrate 1 comprises a first electrode bonding surface 11 and a touch operation surface 12. The first electrode bonding surface 11 of the first substrate 1 forms a first electrode pattern 13. The first electrode pattern 13 comprises a plurality of strip-like electrodes s11, s12, s13, s14, s15, s16, which are substantially parallel to and spaced from each other by a given distance and extend along a first axis X. The first electrode pattern 13 is primarily made of electrically conductive material. The electrically conductive substance can be for example ITO (Indium Tin Oxide), which forms a transparent electrically-conductive layer.

The strip-like electrodes s11, s12, s13, s14, s15, s16 are connected via a first scanning circuit 4 to a microprocessor 3 to be controlled by the microprocessor 3 so that a predetermined driving voltage can be applied to the strip-like electrodes s11, s12, s13, s14, s15, s16, or alternatively, the first scanning circuit 4 carries out scanning to detect the variation of electrical capacitive coupling of the strip-like electrodes s11, s12, s13, s14, s15, s16 and issues a scanning detection signal S1 obtained thereby to the microprocessor 3 for subsequent processing.

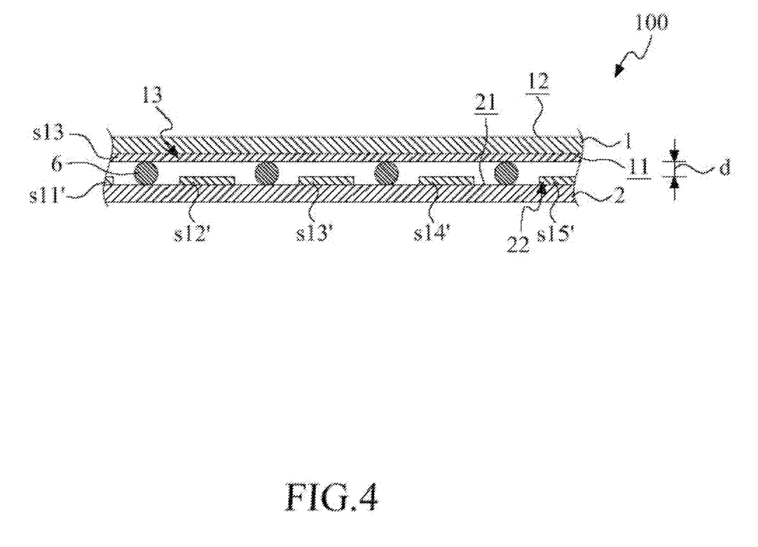

A second substrate 2 comprises a second electrode bonding surface 21 opposing the first electrode bonding surface 11 of the first substrate 1. The second electrode bonding surface 21 of the second substrate 2 forms thereon a second electrode pattern 22. The second electrode pattern 22 comprises a plurality of strip-like electrodes s11′, s12′, s13′, s14′, s15′, s16′, which are substantially parallel to and are spaced from each other by a predetermined distance and extend along a second axis Y. The second substrate 2 is set at a location substantially opposing the first substrate 1 to have the second electrode pattern 22 facing the first electrode pattern 13. A predetermined distance d is defined between the first electrode pattern 13 of the first substrate 1 and the second electrode pattern 22 of the second substrate 2 (as shown in FIG. 4).

The strip-like electrodes s11′, s12′, s13′, s14′, s15′, s16′ are connected via a second scanning circuit 5 to the microprocessor 3 for scanning and detecting variation of voltage occurring in each of the strip-like electrodes s11′, s12′, s13′, s14′, s15′, s16′ and a scanning detection signal S2 is issued to the microprocessor 3 for subsequent processing. In practical applications, each strip-like electrode s11′, s12′, s13′, s14′, s15′, s16′ can be connected to the second scanning circuit 5 by one end or by both ends.

The strip-like electrodes s11, s12, s13, s14, s15, s16 of the first electrode pattern 13 are formed on the first electrode bonding surface 11 of the first substrate 1 in an arrangement of being substantially parallel to and spaced from each other. On local areas between the first electrode pattern 13 and the second electrode bonding surface 21 of the second substrate 2 where no strip-like electrode s11′, s12′, s13′, s14′, s15′, s16′ is set, at least one insulation spacer 6 is provided. With the insulation spacers 6, direct contact between the first electrode pattern 13 and the second electrode pattern 22 can be prevented.

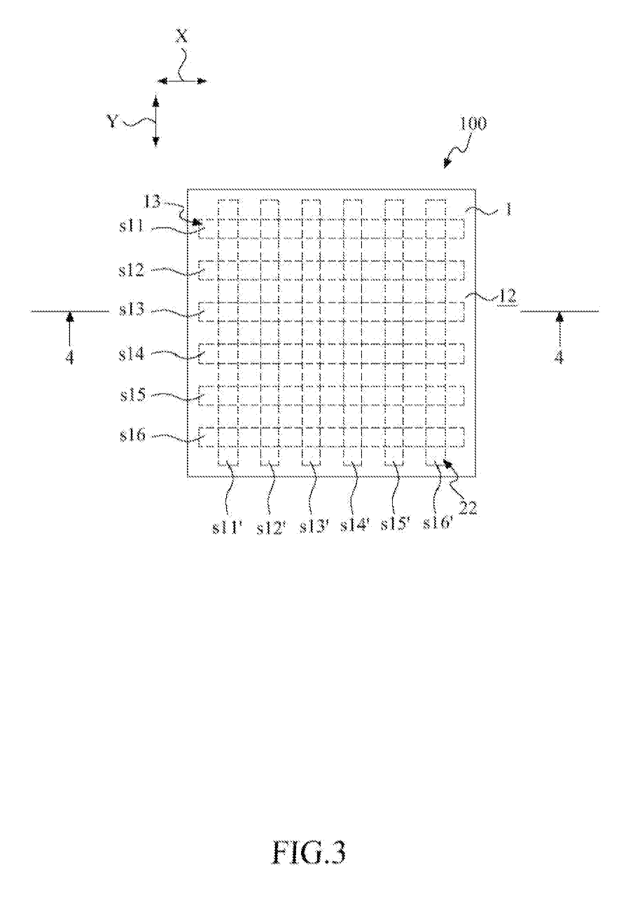

Referring to FIG. 3, which shows the relative positional relationship between the first electrode pattern 13 and the second electrode pattern 22 after the first substrate 1 is bonded to the second substrate 2, in the embodiment illustrated, the first electrode pattern 13 and the second electrode pattern 22 are each illustratively comprised six strip-like electrodes, but it is apparent that the number of the strip-like electrodes is not limited to this and more or less strip-like electrodes can be employed. In a preferred embodiment of the present invention, the strip-like electrodes s11, s12, s13, s14, s15, s16 of the first electrode pattern 13 and the strip-like electrodes s11′, s12′, s13′, s14′, s15′, s16′ of the second electrode pattern 22 are set in an right angle intersecting and overlapping arrangement.

Referring to FIG. 4, the first substrate 1 and the second substrate 2 sandwich therebetween a plurality of insulation spacers 6 to maintain a predetermined distance between the first substrate 1 and the second substrate 2 after they are bonded together, whereby direct contact between the first electrode pattern 13 of the first substrate 1 and the second electrode pattern 22 of the second substrate 2 can be prevented.

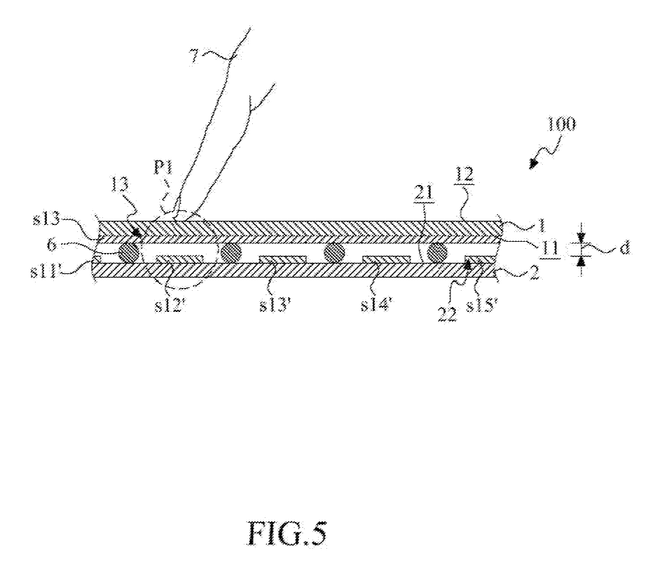

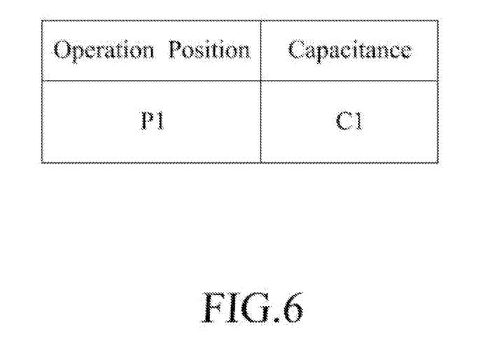

Referring to FIGS. 5 and 6, FIG. 5 demonstrates the touch device of the present invention is operated by a user's finger and FIG. 6 shows a table listing the capacitance corresponding to each touch position demonstrated in FIG. 5. As shown, the example illustrated is used to explain the touch control operation applied to the touch device 100 by means of a touching object 7.

Firstly, in the example illustrated, an operation position occurring at the intersection between the strip-like electrode s13 of the first electrode pattern 13 and the strip-like electrode s12′ of the second electrode pattern 22 is referred to as operation position P1. In the example illustrated, a touching object 7 that is employed to operate the touch device 100 can be for example a finger, a conductive object, or other suitable operating objects.

When the touching object 7 slightly touches a touched position on the touch operation surface 12 of the first substrate 1 to such an extent that the first electrode pattern 13 does not get into physical contact with the second electrode pattern 22 (such as the operation position P1 shown in FIG. 5), under this condition, the touch device 100 is operated with a capacitive touch position detection mode, where the touching object 7 and the strip-like electrode s13 of the first electrode pattern 13 induce a capacitance C1 (see FIG. 6) therebetween due to electrical capacity coupling. The first scanning circuit 4, through scanning each strip-like electrode s11, s12, s13, s14, s15, s16 of the first substrate 1, detects the variation of electrical capacity coupling between the touching object 7 and the first electrode pattern 13 and issues the first scanning detection signal S1 to the microprocessor 3.

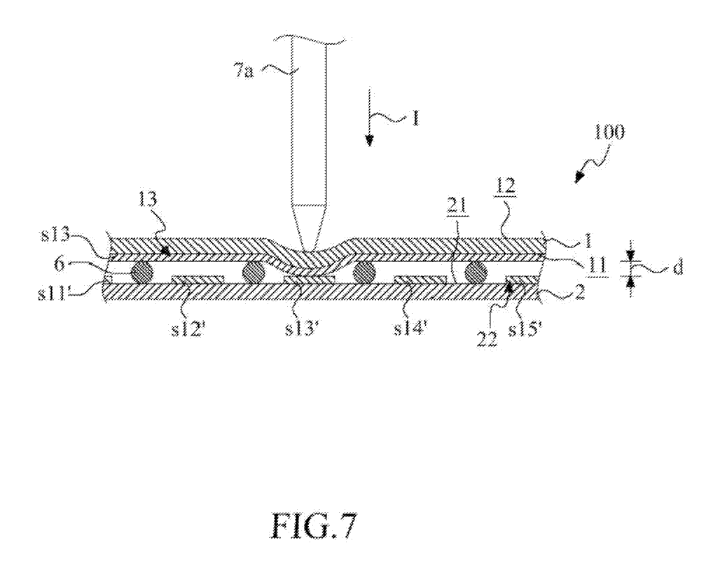

FIG. 7 is a schematic view illustrating that the touch device of the first embodiment of the present invention is operated with a touching object. As shown, a touching object 7a used in the instant example is a conductive object or a non-conductive object (such as a touch stylus or other suitable objects). When the touching object 7a depresses the touch operation surface 12 of the first substrate 1, due to the depression of the first substrate 1 at the operation position, the strip-like electrode s13 of the first electrode pattern 13 and the strip-like electrode s13′ of the second electrode pattern 22 get into contact with each other (the predetermined distance d becoming d=0). Under this condition, the touch device 100 is operated with a resistive touch position detection mode, wherein a driving voltage is applied to the strip-like electrode s13′ and the touch device 100 calculates the operation position of the touching object 7a operating on the touch operation surface 12 of the first substrate 1 according to variation of voltage in the strip-like electrode s13′ of the second electrode pattern 22.

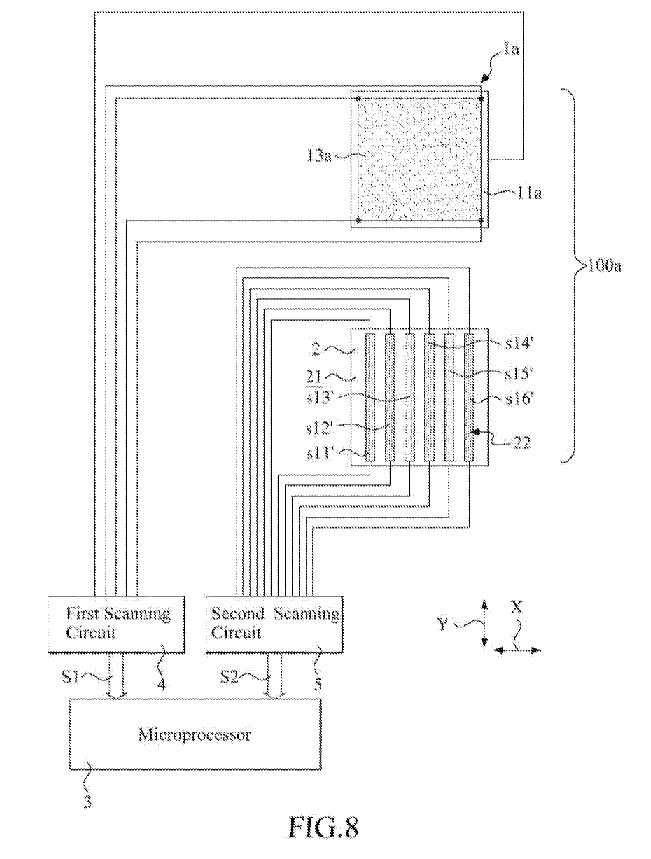

Referring to FIG. 8, which shows a system block diagram in accordance with a second embodiment of the present invention, the second embodiment comprises major constituent components that are identical to the counterparts of the first embodiment and the identical components are designated with the same reference numerals. A difference is that the second embodiment comprises a first substrate 1a that has a first electrode bonding surface 11a and the first electrode bonding surface 11a forms thereon a first electrode pattern 13a that comprises an ITO transparent conductive layer having a continuous planar structure. Four corners of the first electrode pattern 13a are connected to the first scanning circuit 4 in order to allow a driving voltage to be applied thereto to form a voltage gradient in the first electrode pattern 13a.

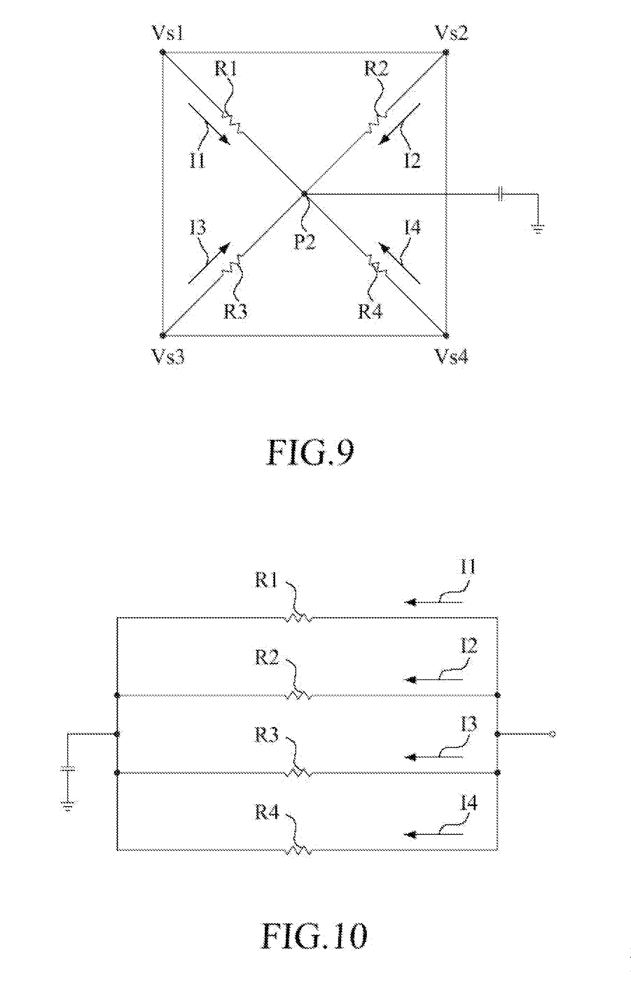

Referring to FIGS. 9 and 10, which are respectively a circuit diagram demonstrating a depression operation applied to the touch device 100a and an equivalent circuit thereof, as shown in FIG. 9, when the touch device 100a is being depressed at an operation position P2, a resistance R1, R2, R3, R4 is induced between the operation position P2 and each corner. As shown in FIG. 9, based on the voltage Vs1, Vs2, Vs3, Vs4 supplied and the corresponding resistance R1, R2, R3, R4, a corresponding current I1, I2, I3, I4 can be calculated, and based on the ratio between the currents I1, I2, I3, I4, the location of the operation position P2 on the touch device 100a can be calculated.

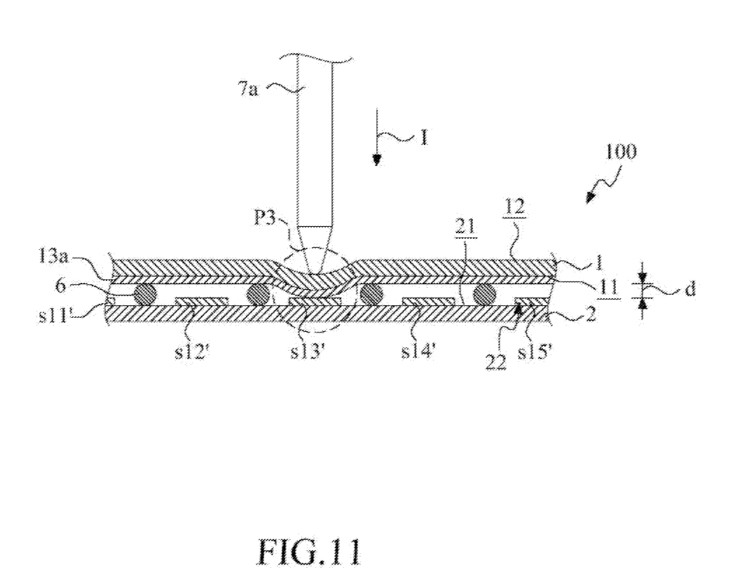

Referring to FIG. 11, which shows a schematic view of the touch device of the present invention being operated with a touching object, firstly, an operation position occurring at the intersection between the first electrode pattern 13a and the strip-like electrode s13′ of the second electrode pattern 22 is referred to as operation position P3. In the instant example, a touching object 7a that is employed to operate the touch device 100a can be a conductive object or a non-conductive object (such as a touch stylus or other suitable objects).

Also referring to FIG. 8, when a user uses the touching object 7a to forcibly depress the first substrate 1a in a given touching direction I, due to the depression of the first substrate 1a at the operation position P3, the first electrode pattern 13a and the strip-like electrode s13′ of the second electrode pattern 22 get into contact with each other (the predetermined distance d becoming d=0). Under this condition, the touch device 100a is operated with a resistive touch position detection mode, wherein the first scanning circuit 4 applies a driving voltage to the first electrode pattern 13a and the driving voltage is transmitted from the first electrode pattern 13a to the strip-like electrode s13′ of the second electrode pattern 22. The second scanning circuit 5 performs scanning and detection and then issues a scanning detection signal S2 to the microprocessor 3. The microprocessor 3 responds to the variation of voltage in the strip-like electrode s13′ of the second electrode pattern 22 and calculates the touched position of the touching object 7a on the first substrate 1.

Although the present invention has been described with reference to the preferred embodiments thereof, it is apparent to those skilled in the art that a variety of modifications and changes may be made without departing from the scope of the present invention which is intended to be defined by the appended claims.

1. A touch detecting device comprising:
a first substrate, comprising a first electrode bonding surface and a touch operation surface;
a first electrode pattern, formed on the first electrode bonding surface of the first substrate;
a second substrate comprising a second electrode bonding surface, wherein the second substrate is arranged at a location opposing the first substrate, further wherein the second electrode bonding surface faces the first electrode bonding surface
a second electrode pattern, formed on the second electrode bonding surface of the second substrate, wherein the second electrode pattern opposes the first electrode pattern; and
a microprocessor electrically connected to the first electrode pattern and the second electrode pattern;
wherein the touch device is set in a capacitive touch position detection mode when the touching object slightly touches the touch operation surface and the touch device is set in a resistive touch position detection mode when the touching object forcibly depresses the touch operation surface.

2. The touch device as claimed in claim 1, wherein each of the first electrode pattern and the second electrode pattern comprise a plurality of strip-like electrodes that are parallel to and spaced from each other.

3. The touch device as claimed in claim 2, wherein the strip-like electrodes of the first electrode pattern are connected to the microprocessor through a first scanning circuit and the strip-like electrodes of the second electrode pattern are connected to the microprocessor through a second scanning circuit.

4. The touch device as claimed in claim 1, wherein the first electrode pattern and the second electrode pattern are spaced from each other by insulation spacers.

5. The touch device as claimed in claim 1, wherein the first electrode pattern comprises a continuous planar structure.

6. (canceled)

7. (canceled)

8. The touch device as claimed in claim 1, wherein the capacitive touch position detection mode comprises change of electrical capacitive coupling between the touching object and the first electrode pattern, further wherein the change is applied to the microprocessor for determination of at least one operation position where the touching object operates on the touch operation surface of the first substrate.

9. The touch device as claimed in claim 1, wherein the resistive touch position detection mode comprises depression of the first substrate at an operation position causing the first electrode pattern and the second electrode pattern to contact each other, further wherein the contact configures the microprocessor to determine at least one operation position where the touching object operates on the touch operation surface of the first substrate according to variation of voltage in the second electrode pattern.

10. The touch device as claimed in claim 1, wherein the touch device is set in the resistive touch position detection mode when a hand writing input operation is performed on the touch operation surface of the first substrate.

11. The touch device as claimed in claim 1, wherein the first substrate and the second substrate are spaced from each other by a predetermined distance.

12. The touch device as claimed in claim 3, wherein the first scanning circuit and the second scanning circuit send scanning detection signals to the microprocessor.

13. A touch device adapted to detect position of a touching object applied to the touch device, the touch device comprising:
a first substrate having a first electrode bonding surface;
a first electrode pattern configured on the first electrode bonding surface;
a second substrate having a second electrode bonding surface;
a second electrode pattern configured on the second electrode bonding surface; wherein corners of the first electrode pattern are connected to a first scanning circuit, further wherein operation position of the touching object is detected based on voltage applied at each of the corners and resistance computed from the operation position at each corner.

14. The touch device as claimed in claim 13, wherein the first scanning circuit applies the voltage at each corner of the first electrode pattern and a driving voltage is transmitted from the first electrode pattern to the second electrode pattern when the first electrode pattern contacts the second electrode pattern upon depression of the touching object on surface of the touch device , further wherein a second scanning circuit issues a detection signal to a microprocessor based on the driving voltage.

15. The touch device as claimed in claim 14, wherein the microprocessor computes the operation position based on the detection signal.

16. The touch device as claimed in claim 13, wherein the first electrode pattern comprises an ITO transparent conductive layer having a continuous planar structure.
